(19) United States
(12) Patent Application Publication
(10) Pub. No.: US 2016/0124756 A1
(43) Pub. Date: May 5, 2016

(54) KEYBOARD-ACCESSIBLE CALENDAR FOR INDIVIDUAL WITH DISABILITIES

(71) Applicant: Bank of America Corporation, Charlotte, NC (US)

(72) Inventors: Brad R. Sadler, San Francisco, CA (US); Jason T. Powell, Charlotte, NC (US); Amy C. Hannaman, Jamesville, MN (US); Anthony D. Guido, Corona, CA (US); Celeste M. Magee, Newark, DE (US)

(21) Appl. No.: 14/527,193

(22) Filed: Oct. 29, 2014

(51) Int. Cl. G06F 9/44; G06F 3/0482; G06F 3/0484

(52) U.S. Cl. CPC G06F 9/4446; G06F 3/04842; G06F 3/0482

(57) ABSTRACT

Apparatus, methods and media for a keyboard-accessible calendar are provided. The apparatus may include, and the methods may provide, a display. The display may display a date field. The date field may receive a date input. The apparatus and methods may include a calendar layer. The calendar layer may be displayed on a screen. The calendar layer may include a pictorial calendar interface. The interface may include a plurality of dates. The apparatus may receive a set of instructions. The instructions may include a first instruction to select the date field. Upon selection of the date field, a cursor may be applied to the date field. The instructions may include a second instruction to toggle from the date field to the calendar layer. The toggling may include receiving a keystroke from the user. The toggling may include moving the focus of the cursor from the date field to the calendar layer.

### BACKGROUND

The Americans with Disabilities Act (“ADA”) provides for a wide range of protections for individuals with mental and physical medical conditions. Included in these protections are provisions to accommodate special needs of these individuals.

The proliferation of computers and handheld electronics has presented unique challenges for individuals with disabilities. In certain scenarios, certain disabled individuals require or prefer the use of a keyboard, without a mouse, for computer navigation.

It would be desirable, therefore, to provide apparatus and methods for keyboard-accessible selection and access to computer programs.

It would be further desirable to provide a calendar utility that allows a disabled individual to select content and navigate using a keyboard.

It would be further desirable to provide a calendar utility that provides for manual entry, navigation and access into the calendar utility.

Therefore, apparatus, methods and media for a keyboard-accessible calendar utility are provided.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with principles of the invention;

FIG. 3 shows an illustrative display in accordance with principles of the invention;

FIG. 4 shows an illustrative display in accordance with principles of the invention;

FIG. 5 shows illustrative information in accordance with principles of the invention;

FIG. 6 shows an illustrative display in accordance with principles of the invention; and

FIG. 7 shows illustrative information in accordance with principles of the invention.

### DETAILED DESCRIPTION OF THE INVENTION

Apparatus, methods and media (collectively referred to herein as a “system”) for providing keyboard-accessible calendar access are provided. The calendar access may be suitable for a user with a disability.

For the sake of illustration, the invention will be described as being performed by a “system.” The “system” may include one or more of the features of the apparatus and methods that are shown or described herein and/or any other suitable device or approach. The “system” may be provided by an entity. The entity may be an individual, an organization or any other suitable entity.

The system may include a display. The display may be an electronic display. The display may be configured to display any suitable information.

The display may be configured to display one or more characters. The display may include a Graphical User Interface (“GUI”).

The display may be a screen, monitor, projector, touch screen, smartphone display, television or any other suitable electronic display.

The system may include a date field. The system may include one or more data fields. The system may display one or more data fields. The system may cause the display to display one or more of the data fields. The data field may be configured to accept and/or include any suitable data.

The data field may be a date field. The date field may be configured to receive an input. The input may be a user input. The user may be the user with a disability.

The user may input the data using a keyboard, keypad, virtual keyboard, mouse, keystroke or other suitable inputs. Other suitable input may include motion sensing or detection.

The input may be a date input. The date may be input using any suitable format. The date may be input using numeric character input. For example, the user may input numeric characters “021714.” In a further example, characters 021714 may correspond to Feb. 17, 2014.

The system may include a layer. The layer may be a calendar layer. The system may display the calendar layer. The system may cause the display to display the calendar layer. The calendar layer may be displayed within a GUI.

The calendar layer may include a calendar interface. The calendar layer may include a pictorial calendar interface. For example, the calendar layer may be displayed as a visual depiction. The visual depiction may include a set of columns and rows. Each of the columns and rows may correspond to a set of dates within a month.

The calendar layer may also include a visual depiction of one or more calendar months. The pictorial calendar interface may include one or more dates. The one or more dates may be dates occurring within a month. The month may be a calendar month.

The system may include a receiver. The system may include a transmitter. The system may include a transceiver. The transceiver may be configured to both receive data and transmit data.

The receiver may be an electronic receiver. The transmitter may be an electronic transmitter. The transceiver may be an electronic transceiver.

The system may receive instructions. The instructions may include a set of instructions. The instructions may be received from the user.

The user may input the instructions into any suitable computing device. Exemplary computing devices include a desktop, laptop, computer, server, tablet, smartphone, phablet, smartwatch, or any other computing device configured to receive data input.

The set of instructions may include a first instruction. The first instruction may include an instruction to select the date field. The transceiver may transmit an instruction to select the date field. The transmitter may transmit an instruction to select the date field. The transceiver may transmit an instruction to the processor. The transmitter may transmit an instruction to the processor. The processor may select the date field.

The selection of the date field may be displayed on the display.

The set of instructions may include an instruction to apply a cursor. The user may instruct the system to apply the cursor to a data field. The system may apply the cursor to the data field. The system may apply the cursor to the date field.

The set of instructions may include a second instruction. The second instruction may include an instruction to toggle between and/or among two or more fields, screens, displays and/or presentations.

The set of instructions may include an instruction to toggle from the date field to the calendar layer. The set of instructions may include an instruction toggle between the date field and the calendar layer.

The toggling may include receiving an input. The input may be a keystroke. The keystroke may be received from the user. The keystroke may also be input by the user. The input may be received by a receiver. The input may be received by a transceiver. The transmitter may transmit an instruction to the processor to toggle between the calendar layer and the date field. The transceiver may transmit an instruction to the processor to toggle between the calendar layer and the date field.

The toggling may include a cursor. The toggling may include moving the focus of the cursor. The system may move the focus from a first field. The system may move the focus to a second field. The system may move the focus from a data field to the calendar layer. The system may move the focus from the calendar layer to the data field.

The cursor may be applied to the data field. The cursor may be applied to the calendar layer.

The data field may be configured in any suitable format. The data field may be displayed in any suitable format.

The data field may be displayed in a MM/DD/YYYY format. For example, the date field may display 10/02/2014. In another example, the data field may be configured to display 10/2/2014. In both examples, the date field may correspond to the date of Oct. 2, 2014.

The data field may be displayed in a DD/MM/YYYY format. For example, the date field may display 12/09/2013. In another example, the data field may be configured to display 12/9/2013. In both examples, the date field may correspond to the date of Sep. 12, 2013.

The data field may be displayed in a MM/DD/YY format. For example, the date field may display 11/09/12. In another example, the data field may be configured to display 11/9/12. In both examples, the date field may correspond to the date of Nov. 9, 2012.

The data field may be displayed in a DD/MM/YY format. For example, the date field may display 04/06/15. In another example, the data field may be configured to display 4/6/15. In both examples, the date field may correspond to the date of Jun. 4, 2015.

The data may be input using a keystroke. The user may input the keystroke. The keystroke may be input using a keyboard. The keystroke may be input using an arrow key. The arrow key may be located on the keyboard.

The arrow key may be an up arrow, down arrow, right arrow, left arrow or any other suitable arrow.

The system may optionally display only the date field. The date field may be displayed on an electronic display. The calendar layer may not be displayed. The calendar layer may be hidden. The date field may receive an input. In response to the input into the date field, the system may display the calendar layer. The calendar layer may be displayed on a screen. The calendar layer may include a pictorial calendar interface. The pictorial calendar interface may include a plurality of dates. The dates may include dates within a calendar month.

The input from the user may include a date input. The input may be a numeric character input. The system may populate the date field with a user input. The date field may be populated with the date input.

In response to the second instruction, the system may move the focus. The focus may include highlighting one or more features within the data field. The focus may be moved to the calendar layer.

The system may receive a selected date. The selected date may include a date selected on the calendar layer. The date may be selected using a keyboard arrow. The selected date may be highlighted or marked using any suitable visual indicator, such as highlighting the date, altering the brightness of the date, underlining the date, changing the color of the date, or any other visual indicator or visual cue. The visual cue may correspond to a visual cue of a new focus position.

The system may focus on the selected date. The system may focus on the selected date within the calendar layer. The system may enlarge the date, alter the color of the date or brighten the date.

The system may receive a key input. The key input may include a selection of the ENTER key. In response to the ENTER key input, the system may exit the calendar layer. In response to the ENTER key input, the system may display the selected date. The selected date may be displayed within the date field. The selected date may be displayed within the date field using any suitable format.

The system may receive a request to move the focus position to a disabled date. The disabled date may include a date that is unavailable, such as a weekend, holiday or date/time with a previously schedule event. A disabled date may include a disallowed date. The date may be disallowed by an administrator. The system may attempt to move the focus position to the disabled date. The disabled date may include a weekend date, holiday, a date disabled for business reasons, or any other suitable reason for disabling a date.

The system may disable underlining. The system may disable underlining of the disabled date. The system may disable underlining of the disabled date within the calendar layer.

The system may disable use of the ENTER key. Use of the ENTER key may be disabled when focus is placed on a disabled date. Disabling of the ENTER key may prevent focus of the selected date within the calendar layer.

The system may, in response to displaying the calendar layer, move the placement of focus of the cursor. The placement of the focus may be moved from the date field. The focus may be moved to the calendar layer.

An exemplary embodiment of keyboard-only calendar access is provided. The system may display the date field. The date field may receive input. An arrow key, such as, for example, the down arrow, may be selected. Upon selection of the arrow key, the system may display the calendar layer.

The system may move the focus from the date field to the calendar layer. The focus may be immediately shifted, upon the appearance of the calendar layer, to the calendar layer. The cursor may be moved using the arrow key. Focus within the calendar layer may be applied to the current calendar date. Navigation within the calendar layer can be accomplished using arrow keys, or with any suitable method. For example, a right or left arrow key may be selected to move focus among dates within the calendar month. In a further example, an up or down arrow key may be selected to alternate between different weeks or months.

Dates within the calendar layer may be highlighted, bolded or underlined using a keyboard selection, such as ENTER key, TAB key or any other suitable key.

Selection of a date within the calendar layer, using a keyboard key, may cause the system to input the selected date into the date field.

The calendar layer may be closed or exited using keyboard input, such as selection of ESC key, or using the tab key to select an escape icon.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

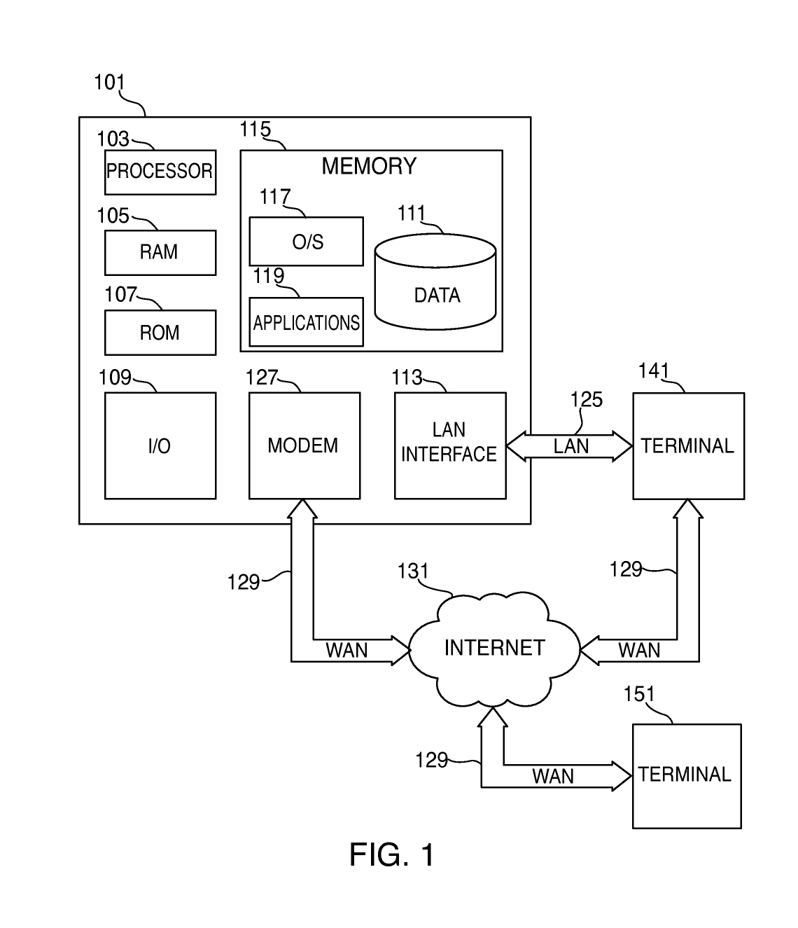

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. I/O module 109 may include any suitable transmitter including hardware. I/O module 109 may include any suitable receiver including hardware.

Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used for any suitable tasks.

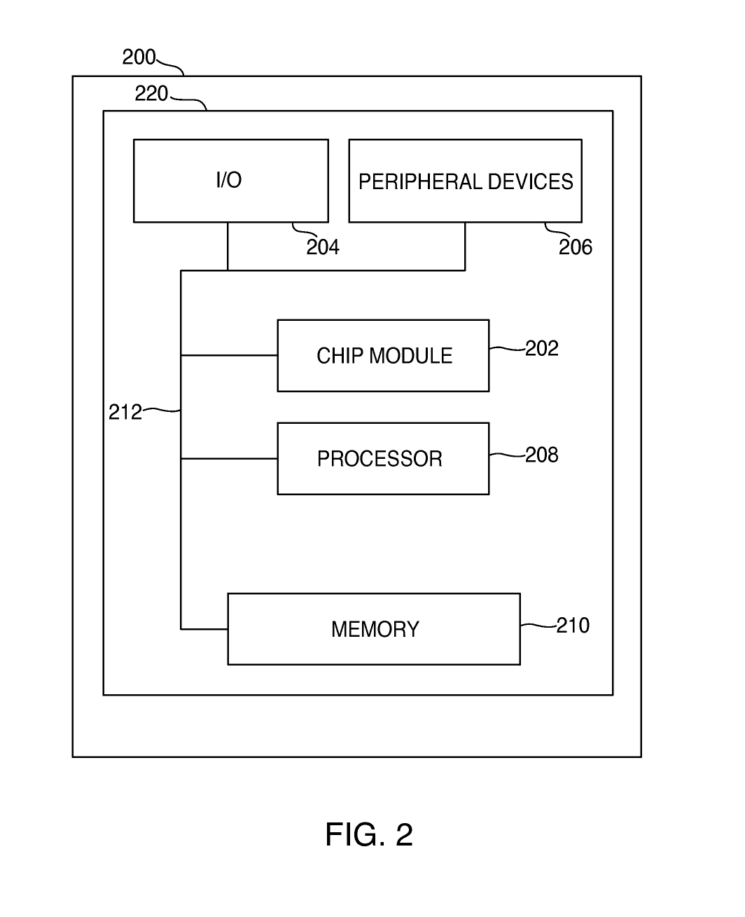

FIG. 2 shows an illustrative apparatus that may be configured in accordance with the principles of the invention.

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, quantify indices; and machine-readable memory 210.

Machine-readable memory 210 may be configured to store in machine-readable data structures: client deposit reports, vault reports, armored courier reports, deposit records and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

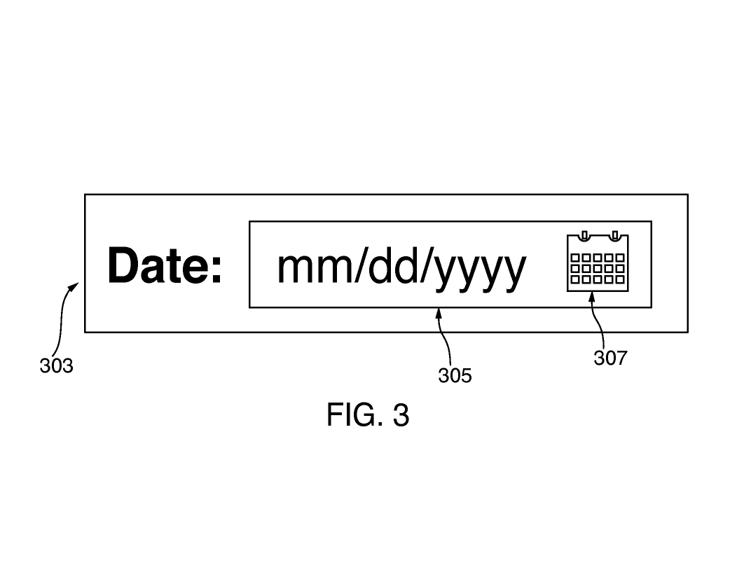

FIG. 3 shows illustrative date picker 303. Date picker 303 may be displayed on a GUI.

Date picker 303 may include date field 305. Date field 305 may include date information. Date field 305 may display a selected date. The selected date may be displayed in alphanumeric characters.

For example, field 305 shows an illustrative display of a date format. Field 305 may display the date in mm/dd/yyyy format. For example, the date may be displayed as 04/03/2014, corresponding to Apr. 3, 2014.

Date picker 303 may include calendar icon 307. Calendar icon 307 may not be selected. Calendar icon 307 may not receive focus. For example, a cursor may be displayed within field 305. A user may select an arrow key. For example, the user may select the down arrow key. In a further example, in response to selection of the down arrow key, the focus may toggle to a calendar layer.

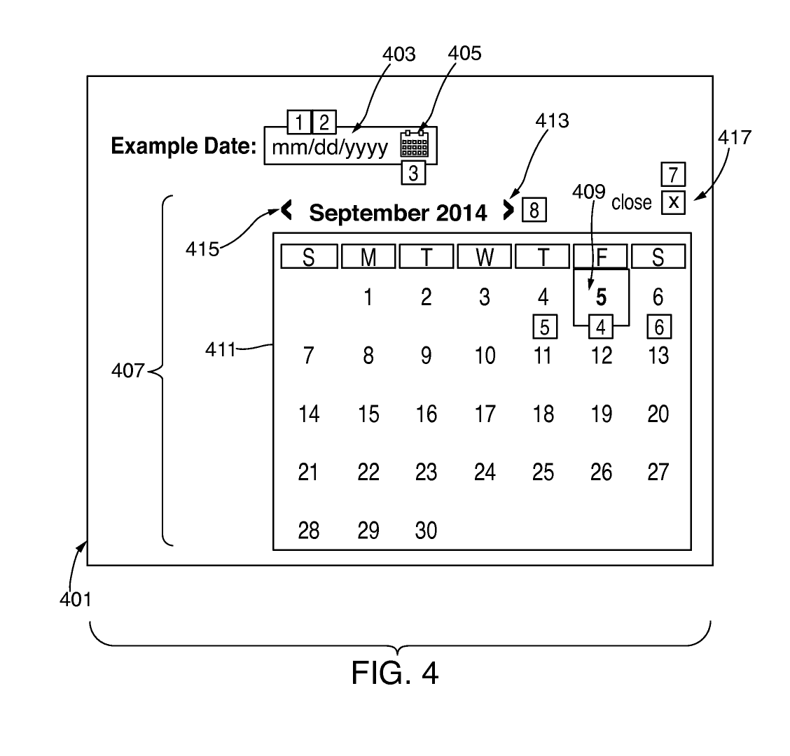

FIG. 4 shows illustrative interface 401. Interface 401 may be viewable after selection of calendar icon 407. Calendar icon 407 may include one or more features icon 307, shown in FIG. 3. Interface 401 may be viewable prior to selection of calendar icon 405. Interface 401 may be accessible after toggling from date field 305.

Interface 401 may include date field 403. Date field 403 may include some or all of the features of date field 305, discussed above in FIG. 3.

Date field 403 may be accessed using an input.

Boxed numbers indicate steps in a process. The system may follow or utilize some or all of these steps. Process steps are now describe as follows:

At step 1, the system may focus on the date field. The system may focus based on receiving the input. In response to focusing, a cursor may be displayed in the date field. In response to focusing, a pop-up calendar may be displayed. The pop-up calendar may be displayed after using an arrow key to expose the calendar layer.

At step 2, a user may input a date. The date may be entered manually into date field 403. The date may be entered in the format shown in date field 403, or any other suitable format.

At step 3, the user may select the down arrow.

Interface 401 may include calendar layer 411. Calendar layer 411 may include a pictorial display of a 28 day, 29 day, 30 or 31 day calendar.

At step 4, focus may move from date field 403 to calendar layer 407. Focus may move within calendar layer 411, to current date 409. Current date 409 may be highlighted, underlined or otherwise cued visually.

At step 5, the user may select an arrow key. In response to arrow key selection, the user may move forward or backwards, up or down, within calendar layer 411. As the user moves to a different date within calendar layer 411, focus may be brought to the new date. The new date may be highlighted, underlined or otherwise cued visually to indicate a new focus position.

Upon selection of a date, the ENTER key may be selected by the user. In response to ENTER key selection, pop-up calendar 411 may close. The selected date from calendar 411 may be displayed within date field 403.

At step 6, the user may attempt to select a disabled date. Disabled dates may be visually indicated as such. For example, difference in shading, brightness, color or any other suitable visual indicator may indicate that one or more dates are disabled. The disabled date may be highlighted, but the date may not be selected. Additionally, selection of the disabled date using the ENTER key may not function. For example, when focus is placed on the disabled date, selection of the ENTER key will not cause the disabled date to be displayed within date field 403.

It should be noted that the disabled date may be selected for the purposes of showing hidden text associated with the date. This selection may occur even when the disabled date is not selectable as a calendar date.

At step 7, the calendar layer may be closed. Interface 401 may include escape icon 417. Escape icon 417 may be selected to close calendar 407. Upon closing calendar 407, focus may be returned to date field 403. For example, the user may select SHIFT and TAB keys to move from current date selection 409 to escape icon 411. In a further example, the user may select the ESC key to close calendar 407.

Interface 401 may include icons 413 and 415. Icons 413 and 415 may be arrow icons. Upon selection of either icon 413 or icon 415, calendar 407 may display the next or previous month, respectively. Visual focus may be brought to selected icon 413 or 415. The visual focus may include an underline of the arrow.

At step 8, the calendar layer may move to the next or previous month.

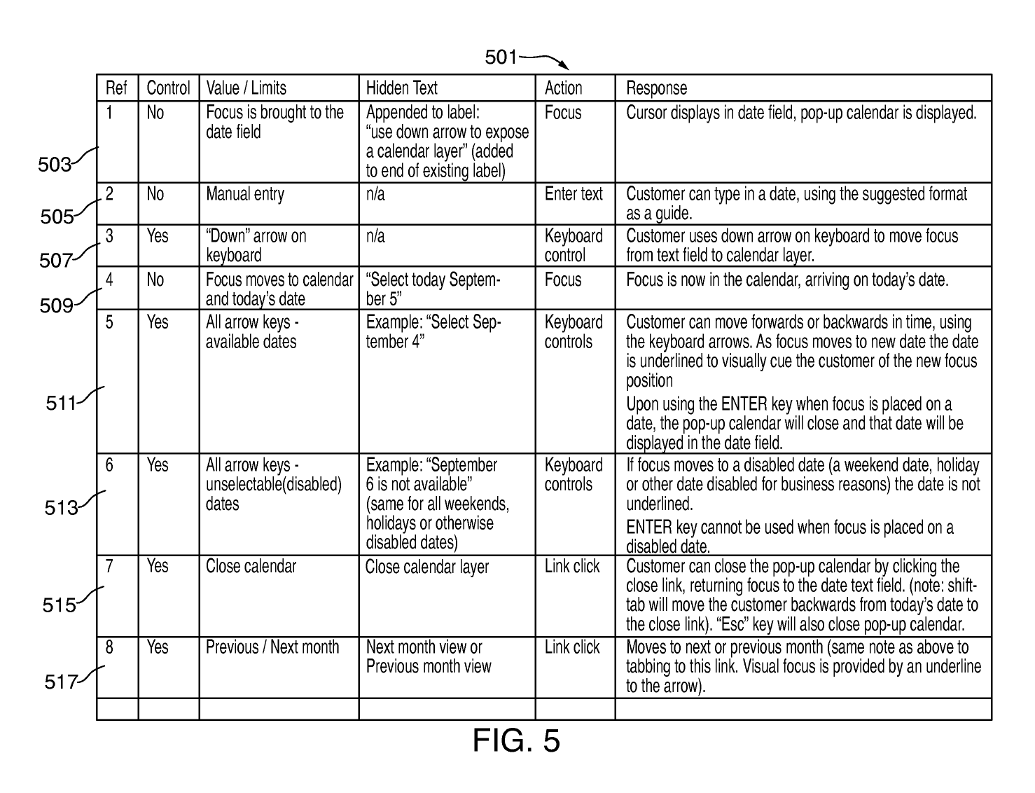

FIG. 5 shows illustrative steps for use of a date field and/or calendar layer.

FIG. 5 may include steps 503, 505, 507, 509, 511, 513, 515 and 517.

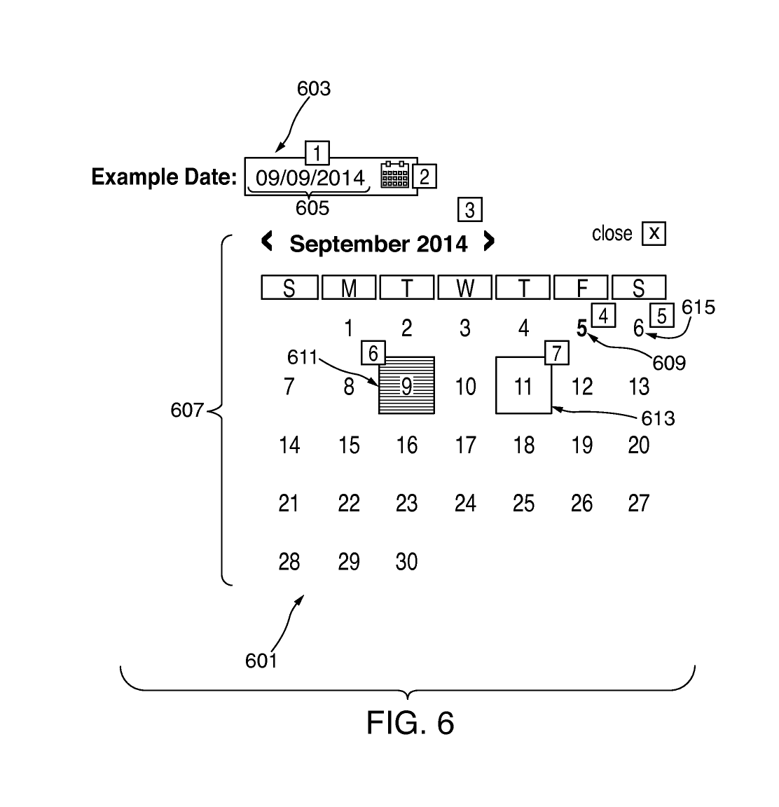

FIG. 6 shows illustrative interface 601.

Interface 601 may include date field 603. Date field 603 may include some or all of the features of date field 303, discussed above in FIG. 3.

Date field 603 may be accessed using an input.

Date field 603 may display date 605. Date 605 may be entered manually. Date 605 may be entered using a calendar layer pop-up. For example, a date may be selected within the calendar layer. The selected date may then be populated into date field 603.

Interface 601 may include calendar layer 607.

Calendar layer 607 may include current date 609. Current date 609 may be displayed in bold font or text. Current date 609 may be displayed in a larger font size than other dates. Current date 609 may be displayed using any suitable visual identifier. The suitable visual identifier may distinguish current date 609 from other dates in calendar layer 607.

Calendar layer 607 may include date 605. Date 605 may be an unavailable date. Date 605 may not be selectable. The cursor may be moved to date 605 and display hidden text. Date 615 may not be populated into date field 603.

Calendar layer 607 may include pre-selected date 611. Date 611 may have been previously selected by the user. The user may then have closed calendar layer. Upon reopening calendar layer 607, the user may see date 611 as selected. The user may move the date selection to another date, other than date 611.

Date 611 may be indicated as selected using a visual identifier, such as shading, highlighting or any other suitable visual cue.

Calendar layer 607 may include date 613. Date 613 may be a date selected by the user as the user moves through calendar layer 607 using arrow or tab keys. Date 613 may be a date that has not been selected by the user for inclusion in date field 603.

The user may utilize the ENTER key to select the date. Upon selection, the date may be input into date field 603.

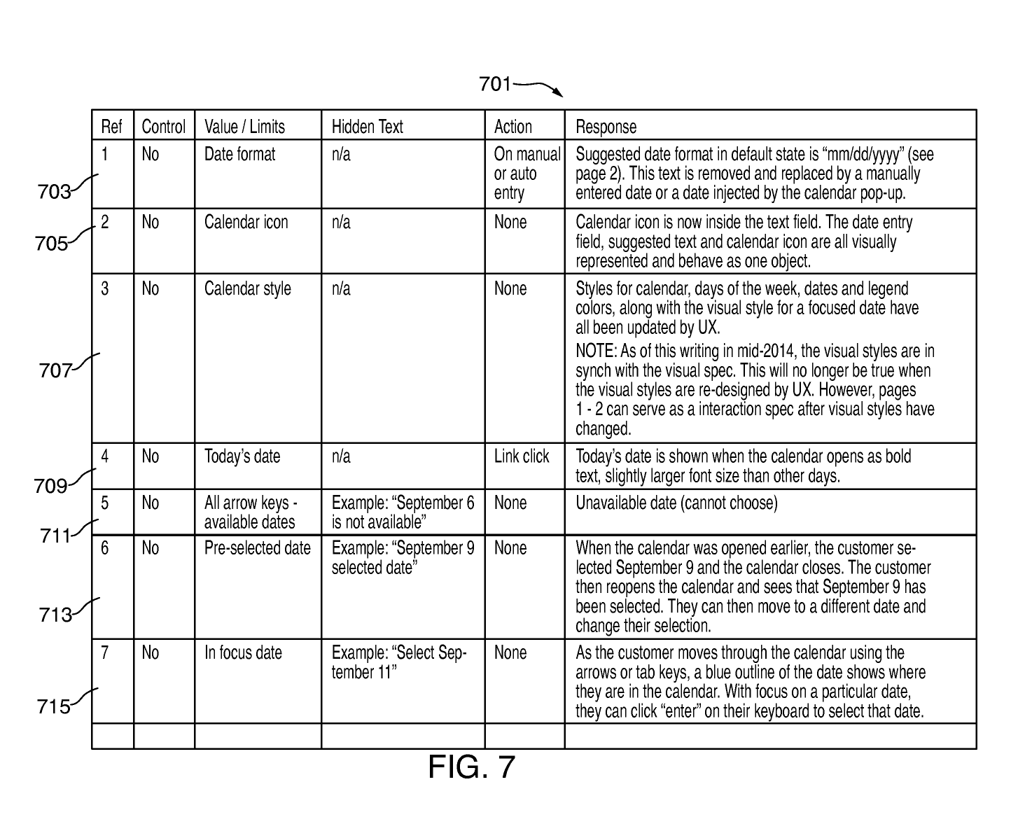

FIG. 7 shows illustrative steps for use of a date field and/or calendar layer.

FIG. 7 may include steps 703, 705, 707, 709, 711, 713 and 715.

Some or all of the actions may be implemented using a control. Controls may include buttons, links, form inputs or any other suitable controls.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for keyboard-accessible calendar access for a person with disabilities have been provided. Persons skilled in the art will appreciate that the present invention can be practiced by other than the described embodiments, which are presented for purposes of illustration rather than of limitation. The present invention is limited only by the claims that follow.

What is claimed is:

1. A method for providing keyboard-accessible calendar access for a user with a disability, the method comprising:
displaying, on a screen, a date field, said date field configured to receive a date input, said date input requiring a numeric character input;
displaying, on the screen, a calendar layer, said calendar layer comprising a pictorial calendar interface, wherein the pictorial calendar interface includes a plurality of dates within a calendar month;
receiving, from the user, a set of instructions, said set of instructions comprising:
a first instruction to select the date field, wherein, upon selection of the date field, a cursor is applied to the date field;
a second instruction to toggle from the date field to the calendar layer, wherein the toggling comprises:
receiving a keystroke from the user; and
moving the focus of cursor from the date field to the calendar layer.

2. The method of claim 1 wherein the date field is selected from a group consisting of:
a MM/DD/YYYY format;
a DD/MM/YYYY format;
a MM/DD/YY format; and a DD/MM/YY format.

3. The method of claim 1 further comprising, in response the second instruction, moving focus to the calendar layer.

4. The method of claim 3 further comprising:
receiving a selected date on the calendar layer using a keyboard arrow; and
highlighting, underlining or cuing visually the date, said highlighting corresponding to a visual cue of a new focus position.

5. The method of claim 4 further comprising:
focusing on the selected date within the calendar layer;
receiving an ENTER key input; and
in response to the ENTER key input:
exiting the calendar layer; and
displaying the selected date within the date field.

6. The method of claim 4 wherein, when the focus position is moved to a disabled date, the method further comprises:
disabling the selection of the disabled date in the calendar layer; and
disabling the ENTER key, wherein, when the ENTER key is disabled, focus of the date within the calendar layer is disabled.

7. The method of claim 1 wherein the keystroke comprises touching an arrow on a keyboard.

8. An apparatus for providing keyboard-accessible calendar access for a user with a disability, the apparatus comprising:
an electronic display, the display configured to:
display a date field, said date field configured to receive a date input, said date input requiring a numeric character input;
display a calendar layer, said calendar layer comprising a calendar interface, wherein calendar interface includes a plurality of dates within a calendar month;
an electronic receiver configured to receive, from the user, a set of instructions, said set of instructions comprising:
a first instruction to select the date field, wherein, upon selection of the date field, a cursor is applied to the date field; and
a second instruction to toggle from the date field to the calendar layer; and wherein the second instruction comprises receiving an input from the user, said input comprising selection of the down arrow key; and
an electronic processor configured to toggle from the date field to the calendar layer, the toggling comprising moving the focus of the cursor from the date field to the calendar layer:

9. The apparatus of claim 8 wherein the calendar interface is a pictorial calendar interface.

10. The apparatus of claim 8 wherein the pictorial calendar interface is a monthly calendar interface.

11. A method for providing keyboard-accessible calendar access for a user with a disability, the method comprising:
displaying, on a screen, a date field, said date field configured to receive a date input, said date requiring a numeric character input;
displaying, on the screen, a calendar layer, said calendar layer comprising a pictorial calendar interface, wherein the pictorial calendar interface includes a plurality of dates within a calendar month; and
displaying a cursor within the date field; and
receiving, from the user, an instruction to toggle from the date field to the calendar layer, wherein the toggling comprises:
receiving a keystroke input from the user; and
moving the focus of the cursor from the date field to the calendar layer.

12. An apparatus for providing keyboard-accessible calendar access for a user with a disability, the apparatus comprising:
an electronic display configured to display a date field;
an electronic receiver configured to receive an input from the user;
an electronic processor configured to cause the display, in response to receiving the input from the user, to display, on the screen, a calendar layer, said calendar layer comprising a pictorial calendar interface, wherein the pictorial calendar interface includes a plurality of dates within a calendar month.

13. The apparatus of claim 12 wherein the input is a date input.

14. The apparatus of claim 13 wherein the processor is further configured to populate the date field with the date input.

15. The apparatus of claim 14 wherein the populated date field is displayed on the electronic display.

16. The apparatus of claim 12 wherein the input is a numeric character input.

17. The apparatus of claim 12 wherein the input is a keystroke.

18. The apparatus of claim 17 wherein the keystroke comprises selecting the down arrow.

19. The apparatus of claim 12 wherein the display is further configured to display a cursor within the date field.

20. The apparatus of claim 19 wherein, in response to displaying the calendar layer, the processor is further configured to toggle the focus of the cursor from the date field to the calendar layer.
